(19) United States
(12) Patent Application Publication
(10) Pub. No.: US 2002/0066874 A1
(43) Pub. Date: Jun. 6, 2002

(54) UV transmittance meter

(76) Inventor: Anushka Drescher, Berkeley, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/730,321

(22) Filed: Dec. 4, 2000

(51) Int. Cl. G01J 1/00

(52) U.S. Cl. 250/504 R

(57) ABSTRACT

A portable ultraviolet light (UV) transmittance meter employs a UV lamp and UV sensor to measure the transmittance of a water sample. The level of UV radiation received when the sample is positioned between the UV sensor and the UV lamp is compared to a level received when a zeroing sample (blank) is positioned in the same location in the same vial. A ratio of the UV signals for the blank and sample is correlated to a transmittance level by a data correlation table or calibration curve. The value provided by the data correlation table is communicated to the user in the form of a transmittance range, within which the sample transmittance falls.

### FIELD OF THE INVENTION

The invention relates generally to the field of water disinfection. More particularly, the invention relates to measuring the UV transmittance of a water sample before disinfection.

### BACKGROUND OF THE INVENTION

Ultraviolet light (“UV light”) can disinfect water by damaging the genetic material (DNA) of microorganisms. Hence, water purification systems sometimes include a stage in which water travels past a UV light source. Gravity-operated systems using air-suspended UV lamps are particularly efficient and therefore are well-suited for use in remote locations and developing countries. An exemplary device is discussed in U.S. Pat. No. 5,780,860, issued Jul. 14, 1998 to Gadgil et al.

Generally a UV water disinfection system can only effectively treat water that allows a high degree of penetration by UV radiation. When the water is turbid and/or contains dissolved material that absorbs UV light strongly, the UV radiation does not penetrate deeply enough into the water and does not reliably disinfect the water, unless a high level of UV radiation is provided. Too high a UV level, however, represents wasted energy when the water to be treated is clear.

Previously, methods of assessing the UV transmittance of water involved the use of equipment that was often bulky and expensive. For example, spectrometers or UV sources with expensive UV radiometers were employed. However, the cost of the equipment made such methods impractical, and it was also impossible to take on-site readings of UV transmittance using such bulky equipment.

Therefore, there is a need for effective and efficient water disinfection using UV light, and for a method for cheaply and readily conducting on-site assessment of the UV transmittance of water to be disinfected.

### SUMMARY OF THE INVENTION

The present disclosure provides a portable device for measuring the UV transmittance of water samples. The device has an ultraviolet (UV) light source or lamp and a UV sensor mounted adjacent to a receptacle that receives a sample water vial. The device can be factory calibrated by measuring the sensor signal for a distilled water sample, in addition to that of several water samples of known UV transmittance spanning a range. Thereafter, transmittance of sample fluid (generally water to be disinfected) can be measured in the field. The transmittance meter is simple and inexpensive, yet it provides a measure of safety when disinfecting water using UV light. The transmittance meter is substantially less bulky and more portable than prior transmittance measurement systems.

The transmittance meter of the preferred embodiment indicates whether the water sample is amenable to disinfection by a particular level of UV radiation, preferably by germicidal UV radiation within a range of approximately 220-280 nm, and most preferably by germicidal UV radiation of 254 nm, at which a peak in germicidal effectiveness is observed. The device is thus particularly suited for operation in conjunction with a disinfection unit using a constant level of UV radiation. The illustrated transmittance meter indicates the range into which the transmittance of a water sample falls.

In accordance with another aspect of the present invention, a method is provided for approximating the transmittance of a water sample by using a transmittance meter. The method includes filling a vial with distilled water and placing the vial into a receptacle of the transmittance meter. The vial is preferably made of quartz to facilitate UV transmittance; however any material which similarly facilitates UV transmittance may be employed. The transmittance meter then measures a UV sensor signal produced by the light from the internal UV lamp after it has passed through the vial of distilled water. Next, a vial (preferably the same vial) is filled with a fluid sample. Another UV sensor signal from UV light that has passed through the vial and the fluid sample is measured by the transmittance meter and is compared to the previous signal produced by the distilled water. The ratio of the two signals is correlated to predetermined calibration values in the transmittance meter's memory to approximate the transmittance level of the water sample.

In accordance with another aspect of the present invention, a UV transmittance meter is provided. The transmittance meter has a vial receptacle with cylindrical walls, a UV lamp positioned at a first end of the vial receptacle, a UV sensor positioned at a second end of the vial receptacle, and a processing unit electronically coupled to the UV lamp and to the UV sensor to measure the UV transmittance of a liquid sample within the vial receptacle.

In accordance with another aspect of the present invention, a method is provided for measuring the transmittance of a liquid sample. The method includes first measuring the level of UV light transmitted through a “blank” having a known transmittance. The level of UV light transmitted through a liquid sample is measured by using the UV transmittance meter. The two measurements are compared to determine the transmittance of the liquid sample, preferably making the comparison with a correlation table or calibration curve.

### BRIEF DESCRIPTION OF THE DRAWINGS

These and other aspects of the invention will be readily appreciated by the skilled artisan in view of the description below and the appended drawings, which are meant to illustrate, but not limit, the invention, and in which:

FIG. 1 is a schematic plan view of a transmittance meter constructed in accordance with a preferred embodiment of the present invention;

FIG. 2 is a schematic view illustrating the internal components of the transmittance meter of FIG. 1;

FIG. 3 is a perspective view of a water testing kit that includes the transmittance meter of FIG. 1;

FIG. 4 is a flow chart generally illustrating a process of measuring the transmittance of a water sample; and

FIG. 5 illustrates the calculation process used by the meter to determine the transmittance of a water sample.

### DETAILED DESCRIPTION OF THE PREFERRED EMBODIMENT

The structure and operation of an embodiment of the present invention will now be discussed with reference to illustrations of a portable UV transmittance meter (herein “transmittance meter” or “meter”). The illustrated transmittance meter is configured to measure the UV transmittance of a water sample, preferably the transmittance of germicidal UV radiation within a range of approximately 220-280 nm, and more preferably the transmittance of germicidal UV radiation of approximately 254 nm. Nonetheless, the skilled artisan will readily find application for the methods and structures disclosed herein for measuring the transmittance of different liquid samples and for radiation of different wavelengths, such as broadband UV radiation, in view of the disclosure herein.

In general, the transmittance meter operates to indicate the UV transmittance of a liquid sample that is within a vial. The vial is positioned in a vial receptacle of the transmittance meter. The operator first “zeroes” the transmittance meter by measuring the transmittance of distilled water prior to measuring the transmittance of the liquid sample. This zeroing step establishes a baseline signal; this is used as the denominator in a signal ratio to be obtained. The zeroing step is most preferably performed prior to each measurement. In other arrangements, the zeroing can be performed once prior to measuring the transmittance of multiple samples in sequence.

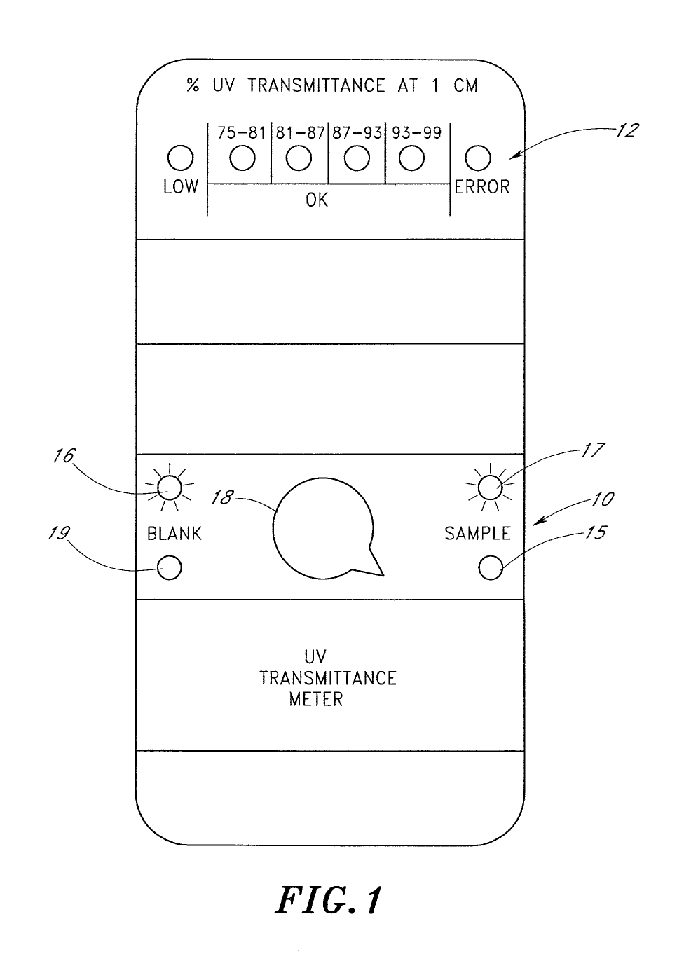

FIG. 1 illustrates the external layout of a transmittance meter 10 of the preferred embodiment. The external layout includes a display area 12, a vial receptacle 18, and a pair of control buttons 15, 19, with associated status indicators in the form of Light Emitting Diodes (“LEDs”) 16, 17. The display area 12 also includes a plurality of indicators or LEDs, which correspond to various transmittance ranges. A printed numerical range of transmittance percentage indicates the transmittance level corresponding to each LED, with 99% transmittance being defined by calibration with distilled water. A “LOW” indicator LED preferably corresponds to a transmittance level that is below 75 percent. An “ERROR” indicator LED preferably corresponds to a transmittance reading higher than that of the distilled water. Although the illustrated “LOW” indicator LED indicates a level below 75 percent, the low range selection can vary depending on the meter's application. For example, certain UV treatment methods (e.g., using high power or low flow rates) can be effective with water having transmittance levels below 75 percent. Accordingly, under such circumstances, the low transmittance LED can indicate a lower range. The transmittance is preferably indicated in the range of 0-99%.

In the illustrated embodiment, the transmittance level is indicated within six percentage intervals: LOW (0-75%); 75-81%; 81-87%; 87-93%; 93-99%; and ERROR (>99%). As described below, the ranges represent true transmittance levels correlated to UV signal ratios to be measured by the device 10. The correlations are performed by factory calibration, comparing ratios measured by the meter 10 with measurements made by spectrometer. The correlations are then stored, e.g., in the form of a look-up table, in memory in the meter 10. Note that, in place of the LEDs indicating transmittance ranges, it is also possible to employ a digital display indicating the actual numerical transmittance value estimated by interpolation.

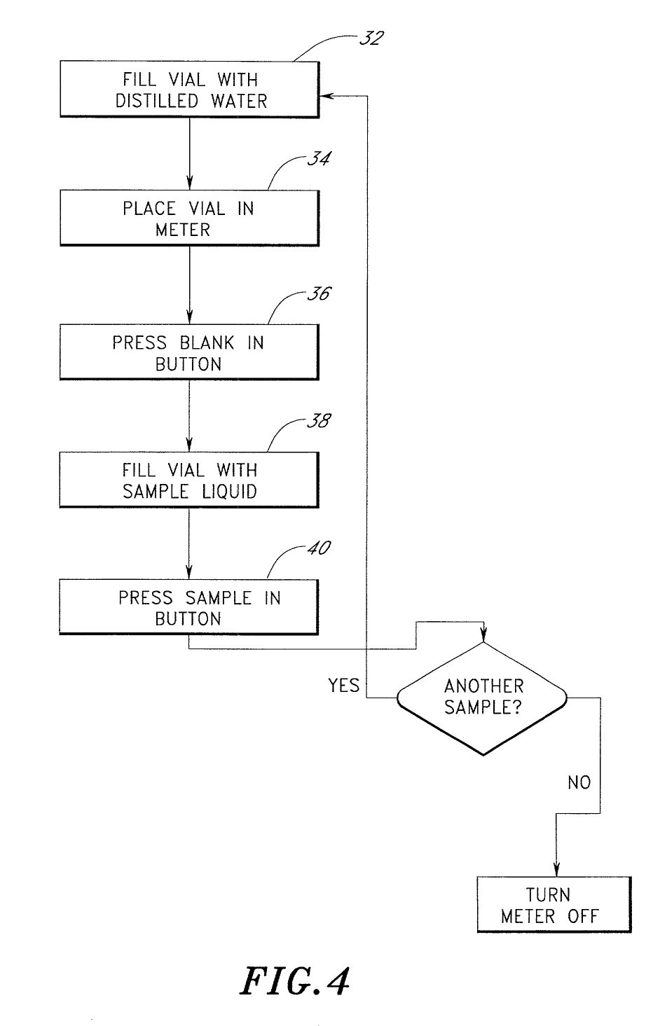

The control buttons 15, 19, are used to set the operation mode of the transmittance meter 10. A “Blank In” button 19 is used to initiate zeroing of the meter by employing a blank vial (i.e., distilled water). A “Sample In” button 15 is used to initiate signal measuring for a liquid sample. The meter's operation is discussed in further detail below with reference to FIG. 4.

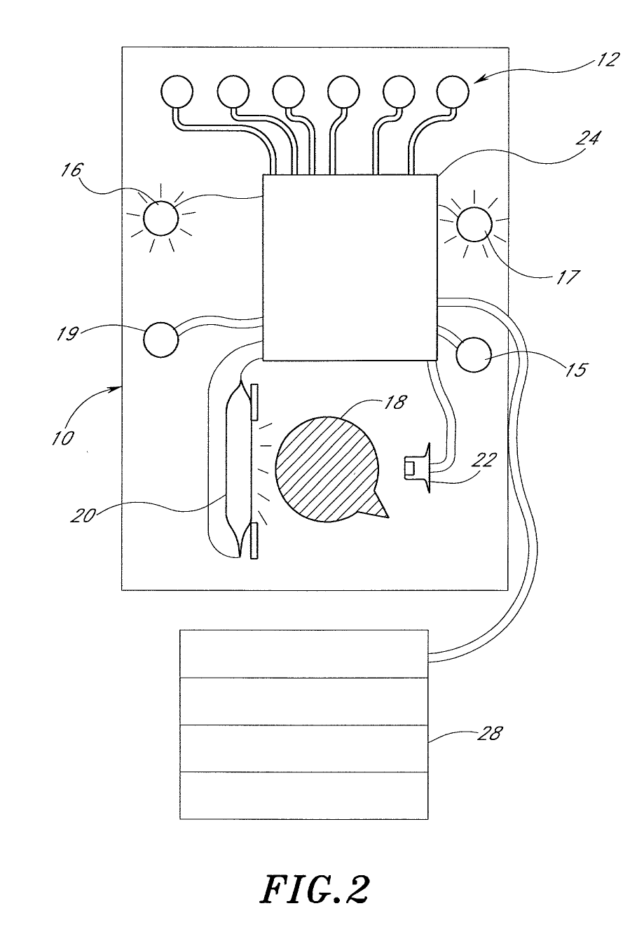

The vial receptacle 18 is used to secure a quartz vial, holding either a blank or a sample to be tested, between a UV lamp and a UV sensor (see FIG. 2 and corresponding text below). The vial is preferably positioned within the receptacle before the meter's operation mode is set. In one embodiment, the vial receptacle includes an indented portion or notch. The indented portion is adapted to mate with a protrusion in the opaque cap (not shown) of the vial so as to secure the vial in place with a consistent orientation.

FIG. 2 illustrates the internal components of the transmittance meter 10. The internal components include a UV lamp 20, a UV sensor 22, an electronics module 24, and a battery compartment 28. The electronics module 24 is electrically coupled to the UV lamp 20 and to the UV sensor 22 to control the generation and sensing of UV radiation. The UV lamp 20 is preferably a commercially available UV lamp from JKL Components Corporation of Pacoima, Calif. under the trade name BF 850-UVC “Cold Cathode Ultraviolet Germicidal Lamp.” The lamp preferably has a power output between approximately 1 mW/cm² and 100 W/cm² at a distance of 25.4 mm, and more preferably between about 20 W/cm² and 40 W/cm² at a distance of 25.4 mm. The UV lamp preferably has the same spectral characteristics as the lamp that is used in the disinfecting system by which the water is to be treated. The UV sensor 22 preferably comprises two solid state photodetectors connected in reverse parallel to measure UV intensity, as disclosed in U.S. application Ser. No. 09/351,964, filed Jul. 12, 1999 and entitled ULTRAVIOLET LIGHT DETECTOR FOR LIQUID DISINFECTION UNIT (“the '964 application”). The '964 application is incorporated by reference herein. The electronics module 24 is further electrically coupled to the battery compartment 28 to receive power from batteries therein. In place of the battery compartment, an adapter for an external power source may be employed. Also, the electronics module 24 includes a memory storing calibration data and is electrically coupled to the control buttons 15, 19, to the status indicator LEDs 16, 17, and to the transmittance indicator LEDs 12.

The UV lamp 20 is positioned next to a window of the vial receptacle 18. The UV sensor 22 is positioned next to a second window of the vial receptacle 18, substantially facing the UV lamp 20. Thus, the radiation emitted by the UV lamp 20 is received by the UV sensor 22. When a water sample vial is in the vial receptacle 18, the radiation emitted by the UV lamp 20 is partially absorbed by the water sample and is affected by the vial itself. For example, a round water-filled vial displayed a lens effect, increasing the level of radiation received by the UV sensor 22 relative to a square vial. When the water in the vial is UV-absorbing, the UV radiation received by the UV sensor 22 decreases compared to the distilled water signal because radiation is absorbed by the water.

By monitoring the decrease in radiation level between a blank (distilled water) and a water sample, the transmittance of the water sample can be determined. Because a ratio of signal reading through distilled water over signal reading through sample fluid is used, the effect of the vial essentially cancels. As noted above, the device of the present invention is associated with a factory calibration that provides a relationship between the ratio of the signals received and actual UV transmittance. This calibration is carried out during the process of manufacturing the transmittance meter and is set in the memory thereof. Accordingly, knowing the transmittance of a “blank” allows for calculating a ratio for the water sample that is then correlated to an actual transmittance. In one embodiment, distilled water, having transmittance of 99% is used as the blank. Nonetheless, other liquid samples of known transmittance can be used to calculate a ratio while an appropriate correlation table (discussed below) is provided for determining the transmittance of the water sample.

In one embodiment, the measured radiation for both blank and sample measurements is a UV radiation intensity measurement at a steady state (consistent level for a predetermined period). The ratio of steady state intensities is then used to determine the transmittance of the liquid sample by comparing the ratio to stored calibration data in memory. Alternatively, the meter can measure the average intensity of UV light over a predetermined time period for the samples.

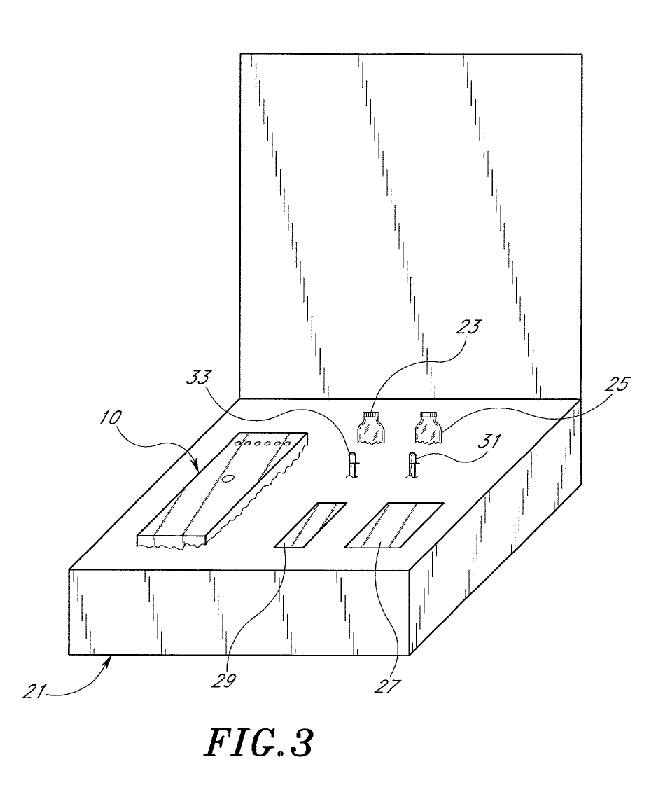

FIG. 3 illustrates a water testing kit 21 that includes the transmittance meter of FIGS. 1 and 2. The kit 21 includes a carrying case with several compartments. The case's interior is preferably padded to protect its contents. The case's compartments are used to hold the transmission meter 10, a bottle of blank fluid (distilled water) 23, a bottle of test sample fluid (80% transmittance) 25, a pair of quartz vials 31, 33 (each with a special opaque vial cap), operating instructions 29, and an optical cleaning cloth 27. The fluids 23 and 25 can be used periodically for the verification of the accuracy of the transmittance meter, i.e., to ensure that the transmittance readings remain true to factory calibration. Since these fluids are used in equal amounts during this operation, the bottles containing fluids 23 and 25 are preferably of the same size. Preferably, the user supplies distilled water separately for regular measurements. One of the vials can be stored filled with distilled water to allow for faster zeroing using the vial, but the factory-provided distilled water 23 is preferably reserved for periodic calibration checks.

The special cap on each vial 31, 33, includes a protrusion that fits into the vial receptacle's notch (FIGS. 1 and 2). Thus, the special cap helps secure the vial in place within the vial receptacle. Furthermore, the special cap is preferably made of an opaque material, which prevents UV radiation from leaking outside the vial receptacle and prevents ambient UV radiation from getting to the sensor during measurement.

FIG. 4 illustrates the steps taken by an operator when measuring the transmittance of a water sample by employing the transmittance meter 10. If necessary, a blank vial is prepared by filling 32 one of the vials with distilled water. As noted, the distilled water employed is preferably separately provided by the user. Alternatively, the distilled water may be provided in the kit as an added accessory, or the size of the bottle holding distilled water 23 may be increased to provide the additional distilled water required for the regular measuring operation. Also, the vial used to hold the distilled water is preferably from the measuring kit. The operator first zeroes or sets a baseline for the ratio by inserting 34 the vial holding a liquid of known transmittance (blank) into the vial receptacle 18 and pressing 36 the “Blank In” button 15. In response, the electronics module 24 powers the UV lamp to transmit UV radiation to the vial. Also, the electronics module 24 powers the UV sensor 22 to initiate the detection of UV radiation. The “Blank In” status LED 16 is set to a blinking mode, indicating that zeroing is in progress. After sufficient time to get a steady-state signal (complete warm-up of the lamp) and measure the UV radiation, the electronics module 24 stops the LED 16 from blinking and sets it to a steady ON state to indicate that the calibration is complete.

Once the meter 10 is zeroed, the operator can measure a signal from UV light passed through a water sample. The operator fills 38 a vial with a sample liquid. The “Sample In” button 15 is then pressed 40. In response, the meter powers the UV lamp and UV sensor. Also, the meter sets the “Sample In” LED 17 to a blinking mode, indicating that the measurement is in progress. The UV radiation received by the UV sensor 22 is measured for a sufficient time period. In one embodiment the measuring time is sufficient to allow the meter to detect the intensity of UV radiation at a steady state. Additionally, once the measurement is complete at a steady state of UV intensity signal, the meter indicates such by stopping the LED 17 from blinking and leaving it in a steady ON state to indicate the end of measurement. Finally, after determining the transmittance level of the water sample, the transmittance meter displays the transmittance by powering an LED corresponding to a transmittance range.

In the preferred embodiment, the user is also provided with the option of verifying the accuracy of the transmittance meter by employing a test sample of known transmittance. For example, the sample may have a transmittance of 80%, as indicated in the discussion of FIG. 3. To test the meter, the user measures the transmittance of the sample by following the steps discussed with respect to FIG. 4, using the distilled water 23 and the known sample 25 (FIG. 3) in steps 32 through 40 (FIG. 4). If the meter indicates a transmittance range outside the 75-81% range, the meter may be faulty. Accordingly, the user may, for example, send the meter back to the vendor for repair or adjustment.

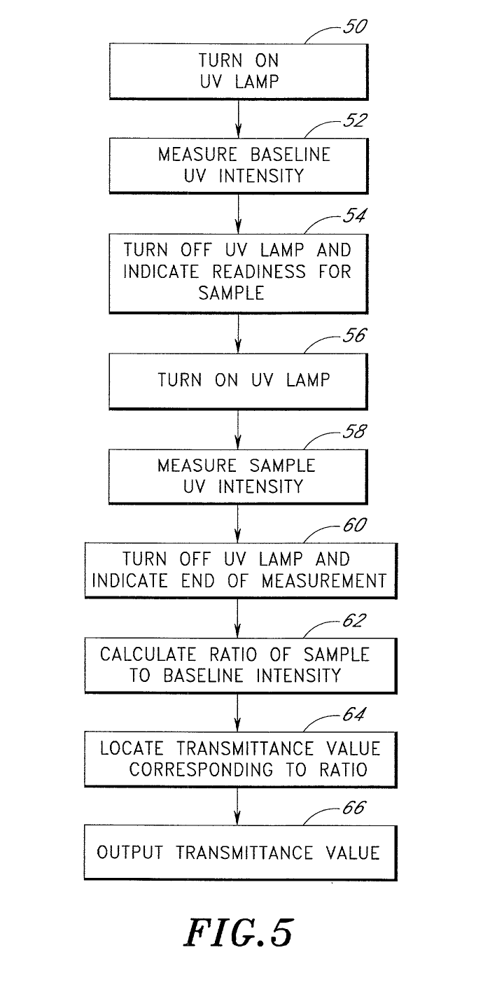

FIG. 5 illustrates the calculation process used by the transmittance meter 10 when measuring the transmittance of a sample. FIGS. 1-4 are also referenced with respect to parts of the meter 10 and actions of the user during measurement. The electronics module 24 of the transmittance meter 10 preferably contains a microprocessor unit that is programmed to implement the process illustrated in FIG. 5. The processor can be, for example, a Microchip Corp. PIC12C508 series processor.

Before measuring the signal from UV transmission through a water sample, the meter 10 is zeroed, as discussed with reference to steps 32-36 of FIG. 4. After placement of the blank vial and in response to user instructions by pressing the “Blank In” button 19, the UV lamp is turned on 50. The baseline level of UV intensity is measured 52 by the UV sensor 22, preferably at steady state. The lamp is then turned off 54 and readiness for the sample is indicated by a steady ON state for the “Blank In” status LED 16.

Following zeroing, when the operator presses the “Sample In” button 15 (FIG. 1), the electronics module 24 again supplies power 56 to the UV lamp 20. The level of radiation received by the UV sensor 22 is again measured 58. Preferably, the radiation level is a measure of the intensity of UV radiation at a steady state. The lamp 20 is again turned off and the LED 17 is stopped from blinking, leaving it in a steady ON state to indicate the end of measurement.

The received radiation level is compared to the radiation level for the blank, measured at step 52. The comparison is preferably in the form of calculating 62 a ratio and using a look-up-table or calibration curve to correlate 64 the calculated ratio to a transmittance level. In one embodiment, the look-up-table is the data space of the processor or other memory that stores a series of values for ratios and corresponding transmittance ranges. The electronics module advantageously queries the look-up-table in the ROM for a desired ratio. Preferably, the look-up-table stores ranges of transmittance ratios, thereby eliminating the need to store every possible ratio in the look-up-table. Alternatively, the processor can be programmed with an algorithm or “curve” to interpolate between ratios corresponding to known (lab measured) transmittances and thereby provide a more precise transmittance value. Accordingly, the transmittance value that is associated with the entry is output 66 to the user by powering the LED 12 (FIG. 1) corresponding to a transmittance range.

The correlation table provides actual transmittance values for UV intensity ratios obtained by the meter 10. Thus, the entries in the correlation table preferably correspond to intensity ratios and associated transmittance levels. In one embodiment, the values in the table are determined by measuring the transmittance of samples in laboratory conditions (e.g., using a spectrometer) and calculating the associated ratio for various samples using the transmittance meter. In other arrangements, the electronic module can include a formula or calibration curve for transforming the UV intensity ratio to a UV transmittance value (e.g., in increments of 1%). Of course, it will be understood that, in its simplest form, the output value need not be numeric and can be selected from a binary choice (e.g., “safe” or “unsafe”).

As may be appreciated, the present invention provides a portable transmittance measuring tool 10 suitable for field use. Preferably, the device 10 is used for a binary decision as to whether a disinfection unit of fixed power is suitable for safe disinfection of the tested water. Alternatively, a water disinfection equipment vendor can go to a customer site and measure the transmittance of the water to be disinfected at the customer site. The vendor can thereby determine which disinfection apparatus is most suitable for the customer based on such measurement. The entire process can take place at the customer site, providing the vendor with a competitive advantage over other vendors in providing the customer with an on-the-spot recommendation as to the disinfection system suitable for the customer's needs based on the testing results. Advantageously, the meter 10 provides actual transmittance through the sample for UV light of the lamp's spectral range.

The transmittance meter 10 can also be used a trouble-shooting tool. If a water disinfection device is not operating optimally (e.g., the germ kill rate has gone down), the user will want to identify the source of the problem. Some disinfection devices include built-in alarms to shut down operation when it appears dosage levels are dropping below acceptable levels. Such decreased performance may be due, for example, to reduced lamp output in the disinfection device. The transmittance meter 10 can identify whether the problem originates with the transmittance level of the water being disinfected, rather than other causes (reduced UV output of the disinfection unit or faulty UV sensor in the disinfection unit).

Other advantages of the meter include its portability, made possible by its low power consumption and relatively small size. The meter is easy to use and does not require any specialized training. Thus, the invention provides a simple and flexible transmittance measuring device.

Although the invention has been described in terms of certain preferred embodiments, other embodiments that are apparent to those of ordinary skill in the art including embodiments which do not provide all of the features and advantages set forth herein are also within the scope of the invention. Accordingly, the scope of the invention is defined by the claims that follow.

I claim:

1. A UV transmittance meter, comprising:
a vial receptacle having a first side and a second side;
a UV lamp positioned adjacent the first side of the receptacle;
a UV sensor positioned adjacent the second side of the receptacle, the second end substantially facing the first side; and
a processing unit electrically coupled to receive signals from the UV sensor to calculate a UV transmittance level of a liquid sample within the receptacle.

2. The UV transmittance meter of claim 1, further comprising a battery cell connected to the processing unit.

3. The UV transmittance meter of claim 1, further comprising a display module connected to the processing unit, the display module providing an indication of the transmittance level of the liquid sample in the receptacle.

4. The UV transmittance meter of claim 3, wherein the display module indicates the transmittance level as falling within one of a plurality of ranges.

5. The UV transmittance meter of claim 4, wherein the plurality of ranges are between about 75 percent and 99 percent.

6. The UV transmittance meter of claim 3, wherein the display module indicates a low transmittance when the UV transmittance level is below a level determined unsafe for a UV disinfection system.

7. The UV transmittance meter of claim 3, wherein the display module indicates an error when the UV transmittance level is above 99 percent.

8. The UV transmittance meter of claim 3, wherein the display module indicates the UV transmittance level by one of a plurality of LED displays.

9. The UV transmittance meter of claim 1, wherein the processor includes a correlator converting signals from the UV sensor to transmittance levels of the liquid sample.

10. The UV transmittance meter of claim 9, wherein the correlator comprises a look-up table.

11. The UV transmittance meter of claim 9, wherein the correlation comprises a calibration curve.

12. A method of measuring the transmittance of a liquid sample, comprising:
measuring a level of UV light transmitted through a zeroing sample;
measuring a level of UV light transmitted through a liquid sample; and
determining a transmittance value for the liquid sample by comparing the level of UV light measured for the zeroing sample to the level of UV light for the liquid sample.

13. The method of claim 12, wherein measuring the level of UV light through the zeroing sample and measuring the level of UV light through the liquid sample comprises measuring an intensity of UV light.

14. The method of claim 13, wherein measuring the level of UV light through the zeroing sample and measuring the level of UV light through the liquid sample further comprises measuring a steady state intensity of UV light.

15. The method of claim 12, wherein measuring the level of UV light through the zeroing sample and measuring the level of UV light through the liquid sample comprises calculating an average UV light intensity over a predetermined time period.

16. The method of claim 12, wherein the zeroing sample is a distilled water sample.

17. The method of claim 12, wherein determining a transmittance value for the liquid sample comprises:
calculating a ratio of the level of UV light transmitted through the zeroing sample to the level of UV light transmitted through the liquid sample; and
correlating the ratio to a transmittance value for the liquid sample.

18. The method of claim 17, wherein comparing the ratio is accomplished by a digital signal processor.

19. The method of claim 17, wherein correlating the ratio comprises:
searching a correlation table for the ratio; and
providing the transmittance value corresponding to an entry in the correlation table for the ratio.

20. The method of claim 17, wherein correlating the ratio comprises:
providing a calibration curve for relating UV level ratios to actual transmittance values; and
determining the transmittance value corresponding to a point on the calibration curve for the ratio.

21. A transmittance meter, comprising:
a vial receptacle for securing a vial in place;
a radiation source for transmitting radiation, the radiation source disposed adjacent a first end of the vial receptacle;
a radiation sensor disposed adjacent a second end of the vial receptacle substantially opposite from the first end to receive radiation transmitted by the radiation source through the vial receptacle; and
processing means for determining the transmittance of a liquid sample held within the vial receptacle, the processing means electrically coupled to the radiation sensor.

22. A transmittance test kit, comprising:
a plurality of compartments;
a transmittance meter disposed within a compartment of the plurality of compartments;
at least one vial disposed within a compartment of said plurality of compartments; and
a liquid zeroing sample disposed within a compartment of said plurality of compartments.

23. The test kit of claim 22, further comprising a liquid test sample of a known transmittance disposed within a compartment of said plurality of compartments.

24. The test kit of claim 23, wherein the transmittance of said test sample is 80%.
